(19) United States
(12) Patent Application Publication
(10) Pub. No.: US 2026/0285222 A1
(43) Pub. Date: Sep. 24, 2026

(54) SYSTEM AND METHOD FOR DETECTING A MOBILE DEVICE AND PROVIDING NOTIFICATION TO AN OPERATOR OF A VEHICLE

(71) Applicants: FCA US LLC, Auburn Hills, MI (US); Stellantis Auto SAS, Poissy (FR)

(72) Inventors: Christopher R Piechocki, Auburn Hills, MI (US); Daniel P Cashen, Auburn Hills, MI (US); Emily A Robb, Auburn Hills, MI (US); Ahmad N Saleh, Auburn Hills, MI (US)

(21) Appl. No.: 19/086,233

(22) Filed: Mar. 21, 2025

(51) Int. Cl. B60Q 1/50; B60Q 1/00; B60Q 5/00; G06V 20/58; G06V 40/20; H04W 4/029

(52) U.S. Cl. CPC B60Q 1/50; B60Q 1/0023; B60Q 5/005; G06V 20/58; G06V 40/20; H04W 4/029

(57) ABSTRACT

A system for providing a notification with a vehicle may include a vehicle communications system configured to communicate with a mobile device, an object detection sensor with a range including an area outside of the vehicle, a notifier, configured to notify an operator of the vehicle outside of the vehicle, and a control system. The control system is configured to receive communication from the vehicle communications system and determine when a mobile device is within an interior of the vehicle, receive communication from the object detection sensor and determine that an operator of the vehicle is outside of the vehicle, provide a notification using the notifier to indicate that the mobile device is within the interior, in at least some locations of the vehicle.

### FIELD

The present disclosure relates to a system and method for detecting a mobile device in a vehicle and providing a notification to an operator of a vehicle.

### BACKGROUND

An operator of a vehicle may bring a mobile device into the vehicle. Upon leaving the vehicle, the operator may unintentionally leave the mobile device in the vehicle.

### SUMMARY

In at least some implementations, a method for providing a notification includes determining a mobile device is within an interior of a vehicle, detecting with an object detection sensor that an operator of the vehicle is outside of the vehicle, and providing a notification to indicate that the mobile device is within the interior, in at least some locations of the vehicle.

In at least some implementations, the notification is provided when a distance between the vehicle and the operator is greater than a predetermined threshold.

In at least some implementations, detecting with an object detection sensor that an operator of the vehicle is outside of the vehicle includes detecting movement of the operator indicating that the operator has exited the vehicle.

In at least some implementations, the notification is provided when a distance between the vehicle and the operator is greater than a predetermined distance.

In at least some implementations, the movement of the operator includes movement of the operator from inside the vehicle to outside the vehicle.

In at least some implementations, the method also includes determining when an operator door of the vehicle is closed, and wherein the notification is provided when the operator is determined to be outside of the vehicle and the operator door is moved to a closed position.

In at least some implementations, the object detection sensor is a camera, a lidar sensor, or a radar sensor.

In at least some implementations, the notification is provided audibly by a horn of the vehicle or a speaker of the vehicle, or visually by a light of the vehicle.

In at least some implementations, the notification is not provided when the vehicle in determined to be located in one or more predefined points of interest.

In at least some implementations, the notification may be provided after a predetermined amount of time has elapsed or when the operator is determined to be farther from the vehicle than a predetermined threshold.

In at least some implementations, a system for providing a notification with a vehicle includes a vehicle communications system configured to communicate with a mobile device, an object detection sensor with a range including an area outside of the vehicle, a notifier, configured to notify an operator of the vehicle outside of the vehicle, and a control system, configured to receive communication from the vehicle communications system and determine when a mobile device is within an interior of the vehicle, receive communication from the object detection sensor and determine that an operator of the vehicle is outside of the vehicle, provide a notification using the notifier to indicate that the mobile device is within the interior, in at least some locations of the vehicle.

In at least some implementations, the notification is provided by the notifier when a distance between the vehicle and the operator is greater than a predetermined threshold.

In at least some implementations, detecting with an object detection sensor that an operator of the vehicle is outside of the vehicle includes detecting movement of the operator indicating that the operator has exited the vehicle.

In at least some implementations, the notification is provided when a distance between the vehicle and the operator is greater than a predetermined distance.

In at least some implementations, the movement of the operator includes movement of the operator from inside the vehicle to outside the vehicle.

In at least some implementations, the system also includes determining when an operator door of the vehicle is closed, and wherein the notification is provided when the operator is determined to be outside of the vehicle and the operator door is moved to a closed position.

In at least some implementations, the object detection sensor is a camera, a lidar sensor, or a radar sensor.

In at least some implementations, the notifier is a horn of the vehicle that is configured to provide an audible notification, a speaker of the vehicle that is configured to provide an audible notification, or a light of the vehicle that is configured to provide a visual notification.

In at least some implementations, the system further comprises a global positioning system, wherein the notification is not provided when the vehicle in determined to be located in one or more predefined points of interest.

In at least some implementations, the notification may be provided after a predetermined amount of time has elapsed or when the operator is determined to be farther from the vehicle than a predetermined threshold.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 shows a perspective view of a vehicle with a system for providing a notification to an operator of a vehicle; and

FIG. 2 shows a flowchart for a method for providing the notification to the operator of the vehicle.

### DETAILED DESCRIPTION

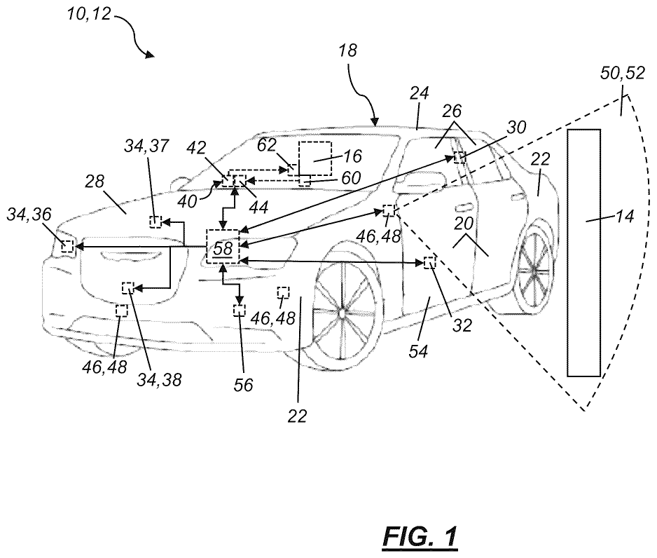

Referring in more detail to the drawings, FIG. 1 shows a vehicle 10 with a system 12 for providing a notification to an operator 14 of a vehicle 10 that a mobile device 16 has been left within the vehicle 10. The vehicle 10 may include a body 18 that has body panels that define at least part of an exterior and an interior of the vehicle 10. The exterior is defined by an outer surface of the body and the interior of the vehicle 10 is the space at least partially enclosed the body 18 of the vehicle 10. As shown in FIG. 1, body panels may include doors 20, fenders 22, a roof 24, windows 26, and a hood 28.

The doors 20 may be configured to provide selective access to the interior of the vehicle 10. For example, in the implementations shown in FIG. 1, there are two left doors on a left side of the vehicle 10 and two right doors on a right side of the vehicle (not shown by FIG. 1). The doors 20 are movable between open and closed positions. In the open position, the doors provide access to the interior, and in the closed position, the doors 20 prevent access to the interior. One or more door position sensors 30 may be associated with each door 20 and may be configured to determine the position of each door 20. For example, the door position sensors 30 may determine when one or more of the doors 20 is in the closed position or is moved at least a threshold amount from the closed position.

The body 18 may include one or more windows 26 that may be at least partially movable to expose a portion of the interior, or may be fixed to one or more body panels or the frame of the vehicle 10. In some implementations, the windows 26 may be movable and stored at least partially within a body panel or door 20 to provide access to the interior of the vehicle 10.

One or more seats may be mounted within the interior of the vehicle 10. At least one of the seats may be configured to support the operator 14 of the vehicle 10, while additional seats may be configured to support other occupants of the vehicle 10. A seat sensor 32 may be integrated with the seat and may be configured to determine whether the operator 14 is in the seat. For example, the seat sensor 32 may be configured to determine when the weight supported by the seat exceeds a predetermined threshold. Although, other implementations of seat sensors 32 are possible, such as, but not limited to optical sensors (e.g. cameras), radar sensors, lidar sensor, and/or motion detectors.

The vehicle 10 includes a powertrain system to propel the vehicle 10. The powertrain system may include an internal combustion engine, one or more electric motors, or a combination of an internal combustion engine and electric motors. The operator 14 of the vehicle 10 may switch the powertrain system between an on position in which the powertrain system can propel the vehicle 10, and an off position using a powertrain control within the interior, which may be an ignition or “on” switch.

The vehicle 10 also includes a notifier 34 that is capable of providing a notification receivable from outside of the interior of the vehicle 10. For example, the notification may be visible or audible from outside of the vehicle 10. The notifier 34 may be one or more vehicle lights 36 configured to provide the notification by flashing or illuminating an area inside or outside of the vehicle 10, a speaker 37, horn 38 or other sound emitter that is audible from outside of the vehicle 10.

A communications device 40 may have a transmitter 42 and a receiver 44. The transmitter 42 of the communications device 40 is capable of transmitting wireless communications and the receiver 44 of the communications device 44 is capable of receiving wireless communications. For example, wireless communications may be cellular, ultra-wideband (UWB), WiFi, satellite communications, radio, Bluetooth, Bluetooth low-energy (BLE), near field communication (NFC), or others. The communications device 40 may be defined by separate components (e.g. for the transmitter 42 and receiver 44) or integrated into a single component depending on the embodiment.

The vehicle 10 has an object detection system 46 with one or more object detection sensors 48 capable of detecting objects outside of the vehicle 10. The object detection sensor 48 may be a camera, lidar sensor, radar sensor, ultrasonic sensor, or other sensor. For example, the camera may produce an image of an area outside of the vehicle 10. The camera may have a lens with a field of view 50 arranged to cover a desired area outside of the vehicle 10. The field of view 50 may extend horizontally away from the vehicle 10 and extend vertically from the ground as shown in FIG. 1. Other cameras and other types of sensors may be used to detect objects by emitting an output over a predetermined area 52, where the output is reflected off objects within the working area of the sensor, and at least some of the reflections are received by the sensor or other receiver.

The object detection sensor(s) 48 may use outputs including light or sound, such as radio waves, ultrasonic sound waves, electromagnetic waves, different ranges or frequencies of light such as infrared or laser light, with non-limiting examples including radar and lidar sensors, among others. In the implementation shown in FIG. 1, at least one object detection sensor 48 is mounted to the body 18 of the vehicle 10 near an operator door 54 and has a field of view 50 or predetermined area 52 including an area outside of the operator door 54 of vehicle 10. Depending on the implementation, the object detection sensor 48 may be located at a different part of the vehicle 10 or the object detection system 46 may include multiple object detection sensors 48 positioned on the vehicle 10.

The vehicle 10 may also include a location sensor 56, such as a global positioning system (GPS) device that may be configured to determine the location of the vehicle 10. The location of the vehicle 10 may be communicated to other vehicle components to enable determination of the vehicle location for different purposes.

A vehicle control system 58 is in communication with the communications device 40 such that the control system 58 can transmit and receive signals and information via the communications device 40. The control system 58 has one or more controllers or processors, memory and instructions or programs stored in the memory or otherwise accessible by the processor(s). In some implementations, the control system 58 may have or be defined by one or multiple vehicle controllers, such as but not limited to, an infotainment module, a telematics module, body control module, powertrain control module, and the like, and the controllers may be independent or networked to each other. Each of the controllers may communicate with one or more vehicle components or system components. The communication device 40 is in communication with the control system 58, and is capable of sending and receiving communication.

In order to perform the functions and desired processing set forth herein, as well as the computations therefore, the control system 58 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller may include input signal processing and filtering to enable accurate sampling and conversion or acquisitions of such signals from communications interfaces and sensors. As used herein the terms controller may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions/programs executable by a processor or controller or the like to enable control or allocate resources of a computing device.

The operator 14 may be a person that controls one or more aspects of the vehicle 10, such as vehicle direction or speed or destination. In implementations where the vehicle 10 is an autonomous vehicle, the operator 14 may be a primary occupant of the vehicle 10 that controls the ignition switch of the vehicle to determine whether the vehicle 10 is powered on or off, or controls the destination of the vehicle 10, or both.

The mobile device 16 has one or more processors, memory, and instructions or programs stored in the memory or otherwise accessible by the processors. The mobile device 16 has a device transmitter 60 capable of transmitting signals wirelessly, and a device receiver 62 capable of receiving signals wirelessly. Communication to and from the mobile device 16 can be any form of wireless communication such as, but not limited to cellular, WiFi, Bluetooth, satellite communications, radio, or others. In some implementations, the mobile device 16 may be configured to provide access to the vehicle 10, such as by unlocking a door, operating a window, or remotely starting or turning on the vehicle 10 or various vehicle functions.

The mobile device 16 may be moved to and from the interior of the vehicle 10 by the operator 14 or another occupant of the vehicle 10. Sometimes, the operator 14 places the mobile device 16 somewhere in the interior of the vehicle 10 during use of the vehicle 10, and the mobile device 16 can then be left behind in the vehicle 10 after the operator 14 leaves the vehicle 10. As mobile devices 16 can be frequently left in places not immediately determinable by the operator 14, this can cause the operator 14 to search for the mobile device 16 and it can be otherwise inconvenient for the operator 14 to not have possession of the mobile device 16 even if the operator 14 remembers that the mobile device 16 is within the vehicle 10. Accordingly, the control system 58 is adapted to determine that the mobile device 16 is within the interior of the vehicle 10 and, with at least one object detection sensor 48, that the operator 14 has left the vehicle 10, and to provide a notification to the operator 14.

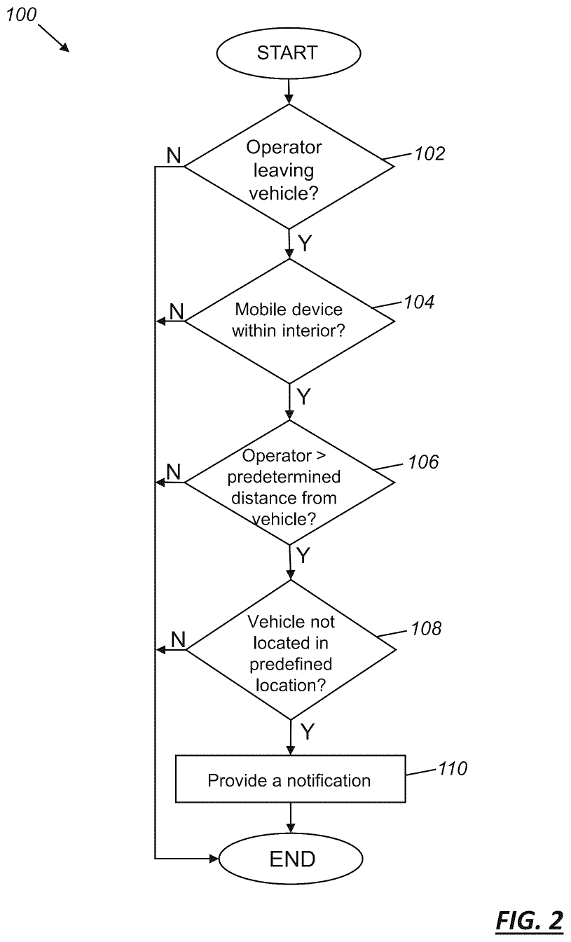

A method 100 for providing a notification to an operator 14 of a vehicle 10 is shown in FIG. 2. The method 100 may begin with step 102, by determining that the operator 14 of the vehicle 10 intends to leave the interior of the vehicle 10. For example, one or more factors such as when the operator door 54, which may be the door 20 closest to where the operator 14 is seated within the interior, leaves the closed position and/or re-enters the closed position, the ignition of the vehicle 10 is switched off, the door locks are locked, the powertrain is shifted to a parked gear or position, or another factor suggests that the operator 14 is intending to exit, in the process of exiting or has exited the vehicle 10.

In step 104, it is determined whether the mobile device 16 is within the interior of the vehicle 10. The control system 58 may utilize the communications device 40 to determine the location of the mobile device 16 relative to the vehicle 10. To determine that the mobile device 16 is within the interior, as shown by FIG. 1, the control system 58 may estimate the distance from the device transmitter 60 of the mobile device 16 to the receiver 44 of the communication device 40 or the distance from the transmitter 42 of the communications device 40 to the device receiver 62 of the mobile device 16 based on the strength of the communication (wireless signal) or from time-of-flight calculations between the mobile device 16 and the communications device 40 of the vehicle 10.

In implementations where the communications device 40 has a single receiver 44 as shown by FIG. 1, the mobile device 16 may be determined to be within the vehicle 10 when the distance between the mobile device 16 and the receiver 44 of the communications device 40 is less than the distance between the boundary of the interior of the vehicle 10. In other implementations, the communications device 40 may have multiple receivers 44 positioned spaced apart throughout the interior of the vehicle 10. The signal strength between the mobile device 16 and each of the receivers 44 may be determined, and the location of the mobile device 16 may be determined relative to each of the receivers 44 as described previously. The distances of the mobile device 16 to each of the receivers 44 may be used to triangulate the location of the mobile device 16 relative to the vehicle 10 to determine whether the mobile device 16 is within the interior of the vehicle 10.

The location of the mobile device 16 relative to the interior may also be determined using time-of-flight calculations, where the distance between the mobile device 16 and the communications device 40 is determined based on the time elapsed between sending and receiving communication between the mobile device 16 and the communications device 40. When the speed at which the communication travels is known, which in some implementations may be the speed of light, the time between sending and receiving communication may be multiplied by the speed of the communication to determine the distance from the mobile device 16 to the receiver 44 of the communications device 40. When the distance calculated from the elapsed time is less than a predetermined threshold, the mobile device 16 may be determined to be within the vehicle 10. Multiple receivers 44 or transmitters 42 of the communications device 40 may be positioned throughout the vehicle 10, the distance may be calculated between each of the receivers 44 or transmitters 42 and the mobile device 16 to triangulate the location of the mobile device 16 relative to the vehicle 10 to determine whether the mobile device 16 is within the interior of the vehicle 10.

If the mobile device 16 is not determined to be within the interior of the vehicle 10, the method 100 may end. If the mobile device 16 is determined to be within the vehicle 10, the method 100 continues to step 106.

In step 106, the object detection system 46 utilizes one or more object detection sensors 48 to detect that the operator 14 of the vehicle 10 is outside of the vehicle 10. For example, the object detection sensor 48 may detect the operator 14 within the object detection sensor's field of view 50 or predetermined area 52 as the operator 14 moves from the interior of the vehicle 10 to outside of the vehicle 10, or when the operator 14 is fully outside of the vehicle 10. In at least some implementations, when the mobile device 16 is determined to be within the interior and the operator 14 is determined to be outside of the vehicle 10, a notification may be provided. This may be coupled with detecting that the door 20 associated with the operator 14 has been opened prior to detecting the presence of the operator 14 outside the vehicle 10, and that the door 20 has been closed after detecting the operator 14 outside the vehicle 10.

In at least some implementations, the notification is not provided until the operator 14 is determined to have moved greater than a predetermined or threshold distance from the vehicle 10. This may prevent notifications being provided when the operator does not leave the area of the vehicle and may reenter the vehicle without leaving the area (e.g. at a refueling station at which the operator exits the vehicle but remains near the vehicle, as one non-limiting example). This may also be coupled with determinations that the operator door 54 has been opened prior to detecting the operator 14 outside the vehicle 10 and closed after detecting the operator 14 outside the vehicle 10, if desired. The distance between the exterior of the vehicle 10 and the operator 14 may be determined in real time as the object detection sensor 48 tracks the operator 14 as he or she moves within the field of view 50 or predetermined area 52 of the object detection sensor(s) 48. The distance of the operator 14 from the vehicle 10 may be communicated to or determined by the control system 58 in real time. The control system 58 may compare the determined distance to the threshold or predetermined distance to determine whether the operator 14 is farther than the predetermined distance from the vehicle 10.

In step 108, the location sensor 56 determines a location of the vehicle 10 and communicates the location of the vehicle 10 to the control system 58. The control system 58 may determine whether the determined location is on a list or satisfies predetermined criteria of locations that may be saved in the memory of the control system 58 or otherwise obtained by the control system 58. In some implementations, the list or criteria of locations may include predefined points of interest where the operator 14 does not require the notifier 34 to provide the notification, regardless of whether the mobile device 16 is within the interior, even when the operator 14 is farther than the predetermined distance from the vehicle 10. For example, at locations where the operator 14 may commonly travel to and from the vehicle 10 in a short period of time, such as at a refueling/recharging station, at a convenience store, or at locations where the operator 14 is learned to return to the vehicle 10 after a short/threshold amount of time (e.g. which may be tracked over time), to name a few.

At these locations, it may be undesirable to notify the operator 14 that the mobile device 16 is within the vehicle 10, when the operator 14 either intends to leave the mobile device 16 in the vehicle 10 or is likely to return to the vehicle 10 in a short period of time. As another example, the list of locations may include locations where the operator 14 wishes to be notified when the mobile device 16 is left in the vehicle 10. For example, the operator 14 may wish to be notified when the vehicle 10 is at the operator's place of work, at the operator's home, or elsewhere and the mobile device 16 is left in the vehicle 10. If the control system 58 determines that the vehicle 10 is located at a location where the operator 14 does not want to be notified, the method 100 may end.

In step 110, a notification is provided by the notifier 34 to indicate that the mobile device 16 is within the interior of the vehicle 10. As previously described, the notifier 34 may provide the notification so that it is receivable or detectable outside of the vehicle 10 by the operator 14. For example, the notifier 34 may be one or more visible or audible sources, such as lights 36 of the vehicle 10, a horn 38 of the vehicle 10, or a speaker 37 of the vehicle 10. The notification may be visually, audibly, or a combination of visually and audibly provided by the notifier 34 to indicate that the mobile device 16 is within the interior of the vehicle 10, in at least some locations of the vehicle 10.

Upon receiving the notification, the operator 14 may be reminded that the mobile device 16 was left in the interior of the vehicle 10. This may prevent the operator 14 from leaving the mobile device 16 behind. The notification can ensure that the operator 14 has possession of the mobile device 16 when leaving the vehicle 10. Furthermore, when the mobile device 16 is an access device (e.g. a key fob) or is acting as an access device for the vehicle 10, the notification may prevent accidental locking of the doors 20 of the vehicle while the mobile device 16 is within the interior, potentially rendering the vehicle 10 inaccessible or more difficult to access.

What is claimed is:

1. A method for providing a notification, comprising:
determining a mobile device is within an interior of a vehicle;
detecting with an object detection sensor that an operator of the vehicle is outside of the vehicle; and
providing a notification to indicate that the mobile device is within the interior, in at least some locations of the vehicle.

2. The method of claim 1, wherein the notification is provided when a distance between the vehicle and the operator is greater than a predetermined threshold.

3. The method of claim 1, wherein detecting with an object detection sensor that an operator of the vehicle is outside of the vehicle includes detecting movement of the operator indicating that the operator has exited the vehicle.

4. The method of claim 3, wherein the notification is provided when a distance between the vehicle and the operator is greater than a predetermined distance.

5. The method of claim 3, wherein the movement of the operator includes movement of the operator from inside the vehicle to outside the vehicle.

6. The method of claim 5, which also includes determining when an operator door of the vehicle is closed, and wherein the notification is provided when the operator is determined to be outside of the vehicle and the operator door is moved to a closed position.

7. The method of claim 1, wherein the object detection sensor is a camera, a lidar sensor, or a radar sensor.

8. The method of claim 1, wherein the notification is provided audibly by a horn of the vehicle or a speaker of the vehicle, or visually by a light of the vehicle.

9. The method of claim 1, wherein the notification is not provided when the vehicle in determined to be located in one or more predefined points of interest.

10. The method of claim 1, wherein the notification may be provided after a predetermined amount of time has elapsed or when the operator is determined to be farther from the vehicle than a predetermined threshold.

11. A system for providing a notification with a vehicle comprising:
a vehicle communications system configured to communicate with a mobile device;
an object detection sensor with a range including an area outside of the vehicle;
a notifier, configured to notify an operator of the vehicle outside of the vehicle; and
a control system, configured to receive communication from the vehicle communications system and determine when a mobile device is within an interior of the vehicle, receive communication from the object detection sensor and determine that an operator of the vehicle is outside of the vehicle, provide a notification using the notifier to indicate that the mobile device is within the interior, in at least some locations of the vehicle.

12. The system of claim 11, wherein the notification is provided by the notifier when a distance between the vehicle and the operator is greater than a predetermined threshold.

13. The system of claim 11, wherein detecting with an object detection sensor that an operator of the vehicle is outside of the vehicle includes detecting movement of the operator indicating that the operator has exited the vehicle.

14. The system of claim 13, wherein the notification is provided when a distance between the vehicle and the operator is greater than a predetermined distance.

15. The system of claim 13, wherein the movement of the operator includes movement of the operator from inside the vehicle to outside the vehicle.

16. The system of claim 15, which also includes determining when an operator door of the vehicle is closed, and wherein the notification is provided when the operator is determined to be outside of the vehicle and the operator door is moved to a closed position.

17. The system of claim 11, wherein the object detection sensor is a camera, a lidar sensor, or a radar sensor.

18. The system of claim 11, wherein the notifier is a horn of the vehicle that is configured to provide an audible notification, a speaker of the vehicle that is configured to provide an audible notification, or a light of the vehicle that is configured to provide a visual notification.

19. The system of claim 11, further comprising a global positioning system, wherein the notification is not provided when the vehicle in determined to be located in one or more predefined points of interest.

20. The system of claim 11, wherein the notification may be provided after a predetermined amount of time has elapsed or when the operator is determined to be farther from the vehicle than a predetermined threshold.
